(19) United States
(12) Patent Application Publication
(10) Pub. No.: US 2026/0095697 A1
(43) Pub. Date: Apr. 2, 2026

(54) SYSTEM FOR MITIGATING MECHANICAL RATTLE IN A COMPUTING DEVICE

(71) Applicant: Cirrus Logic International Semiconductor Ltd., Edinburgh (GB)

(72) Inventors: Jeffrey D. ALDERSON, Austin, TX (US); Kurt EFAW, Austin, TX (US); Brad ZWERNEMANN, Auston, TX (US); Jon EKLUND, Auston, TX (US)

(73) Assignee: Cirrus Logic International Semiconductor Ltd., Edinburgh (GB)

(21) Appl. No.: 18/901,110

(22) Filed: Sep. 30, 2024

(51) Int. Cl. H04R 3/04

(52) U.S. Cl. CPC H04R 3/04; H04R 2430/01

(57) ABSTRACT

A system for mitigating mechanical rattle in a computing device arising due to a mechanical coupling of a speaker of the computing device to a part of the computing device, wherein the computing device comprises a processing subsystem comprising one or more processors configured to execute operating system software and a software application, the system comprising: a rattle mitigation subsystem operative to apply an attenuation function to attenuate a component of an audio signal output to the speaker, wherein the rattle mitigation subsystem is configured to receive, from the computing device, an indication of an operational parameter of the computing device, and to adjust the attenuation function based on the received indication.

### FIELD OF THE INVENTION

The present disclosure relates to a system for mitigating mechanical rattle in a computing device arising due to a mechanical coupling of a speaker of the computing device to a part of the computing device.

### BACKGROUND

Computing devices such as laptop computers, tablet computers and all-in-one desktop computers typically contain one or more acoustic transducers (e.g. loudspeakers) for generating audible outputs from an audio system of the device. The acoustic transducers are typically mechanically coupled to (e.g. mounted on) a part of the device, e.g. a frame, chassis, casing or housing of the device.

Due to size, design and manufacturing constraints, these speaker mounting configurations typically allow low frequency energy in the audio spectrum from the audio output by the acoustic transducer to translate directly into the frame, chassis, casing or housing of the device with minimal damping. Depending on the spectral content of a signal output by the audio system to the acoustic transducer, this leakage of energy from the acoustic transducer can cause mechanical resonance of the whole or part of the device to which the transducer is mechanically coupled, generating secondary noise.

A result of this mechanical resonance is audible non-harmonic distortion (which may be referred to as mechanical rattle) that may be detrimental to the experience of a user of the device and may reduce audio fidelity in the output of the acoustic transducers.

Systems have been developed for reducing distortion introduced by a speaker. Such systems may use a masking scheme to reduce mid-band frequency content in an audio signal supplied to the speaker when high frequency content is low compared to mid-band frequency content. Such systems generally apply time domain analysis and attenuate a broad range of frequencies, which may be selected based on arbitrary and subjective tuning. However, such mid-band attenuation can be perceived by a listener as a large volume reduction. Additionally, any masking content that may be added to the audio signal to mask distortion may be perceived by a listener as unwanted coloring of sound.

Moreover, although such systems may reduce or mask distortion introduced by the speaker itself, they do not address the problem of mechanical resonance or rattle arising due to a mechanical coupling of an audio output transducer (e.g. a speaker) to part of a host device such as a computing device.

### SUMMARY

According to a first aspect, the invention provides a system for mitigating mechanical rattle in a computing device arising due to a mechanical coupling of a speaker of the computing device to a part of the computing device, wherein the computing device comprises a processing subsystem comprising one or more processors configured to execute operating system software and a software application, the system comprising: a rattle mitigation subsystem operative to apply an attenuation function to attenuate a component of an audio signal output to the speaker, wherein the rattle mitigation subsystem is configured to receive, from the computing device, an indication of an operational parameter of the computing device, and to adjust the attenuation function based on the received indication.

The rattle mitigation subsystem may be configured to adjust the attenuation function based on the received indication by: adjusting a tuning of the attenuation function; and/or adjusting a filter coefficient of one or more filters implemented by the rattle mitigation subsystem; and/or selecting, from a set of predefined attenuation functions, a particular attenuation function; and/or adjusting a level of attenuation applied by the attenuation function; and/or adjusting a frequency profile of the attenuation function; and/or adjusting an input signal level threshold at which the attenuation function is to be applied; and/or adjusting an attack rate of the attenuation function.

The indication may comprise one or more of: an audio content type indication indicative of the type of audio content represented by the audio signal; a lid angle indication indicative of an angle or orientation of a lid or screen portion of the computing device with respect to a body portion of the computing device; a body angle indication indicative of an angle or orientation of the body portion of the computing device with respect to a reference orientation; a device age indication indicative of an age of the computing device; and a user rattle mitigation configuration indication indicative of a user configuration of one or more parameters of the rattle mitigation subsystem.

The operating system software may be configured to generate the audio content type indication based on a software application that is being executing by the processing subsystem.

The rattle mitigation subsystem may be configured to: responsive to receiving a first audio content type indication: adjust the attenuation function such that it applies a first predefined level of attenuation to a first subset of signal components of the audio signal; responsive to receiving a second content type indication: adjust the attenuation function such that it applies a second predefined level of attenuation, lower than the first predefined level of attenuation, to the first subset of signal components of the audio signal; and responsive to receiving a third content type indication: adjust the attenuation function such that it applies a third predefined level of attenuation to the first subset of signal components of the audio signal.

The processing subsystem or the operating system software may be configured to generate the lid angle indication based on a signal received from a lid angle sensor of the computing device.

The processing subsystem or the operating system software may be configured to generate the body angle indication based on a signal received from a body angle sensor of the computing device.

The processing subsystem or the operating system software may be configured to generate the device age indication based on one or more of a BIOS date or serial number of the computing device.

The processing subsystem or the operating system software may be configured to generate the user rattle mitigation configuration indication based on a user input to a user interface of the computing device.

The user interface of the computing device may comprise a rattle mitigation control for user configuration of a parameter or a combination of two or more of the following parameters of the attenuation function: a level of attenuation applied by the attenuation function; and/or a frequency profile of the attenuation function; and/or an input signal level threshold at which the attenuation function is to be applied; and/or an attack rate of the attenuation function.

The user interface of the computing device may comprise controls for user configuration of: a level of attenuation applied by the attenuation function; and/or a frequency profile of the attenuation function; and/or an input signal level threshold at which the attenuation function is to be applied; and/or an attack rate of the attenuation function.

The rattle mitigation subsystem may be operative to apply the attenuation function only if a level of the audio signal is equal to or greater than a threshold audio signal level.

The system may be configured to control an operating mode of the rattle mitigation subsystem based on a comparison of a volume setting of the computing device to a predefined volume threshold.

The processing subsystem may be configured to: cause the rattle mitigation subsystem to enter a low-power mode of operation if the volume setting is below the predefined volume threshold; and cause the rattle mitigation subsystem to exit the low-power mode if the volume setting is equal to or greater than the predetermined volume threshold.

The processing subsystem may be configured to perform the comparison periodically and/or in response to a trigger condition.

The system may be configured to cause the rattle mitigation subsystem to enter a low-power mode of operation responsive to detection of an external accessory device that includes an audio output transducer being coupled to the computing device.

The system may be configured to cause the rattle mitigation subsystem to enter a low-power mode of operation responsive to start-up of a software application that includes audio processing functionality.

The system may be configured to disable audio processing functionality of a software application responsive to start-up of the software application.

According to a second aspect, the invention provides a system for mitigating mechanical rattle in a host device arising due to a mechanical coupling of a speaker of the host device to a part of the host device, the system comprising: a rattle mitigation subsystem operative to apply an attenuation function to attenuate a component of an audio signal output to the speaker, wherein the rattle mitigation subsystem is configured to adjust a tuning of the attenuation function based on an input to the rattle mitigation subsystem indicative of a type of audio content represented by the audio signal.

According to a third aspect, the invention provides a system for mitigating mechanical rattle in a host device arising due to a mechanical coupling of a speaker of the host device to a part of the host device, the system comprising: a rattle mitigation subsystem operative to apply an attenuation function to attenuate a component of an audio signal output to the speaker, wherein the rattle mitigation subsystem is configured to adjust a parameter of the attenuation function based on a type of audio content represented by the audio signal.

According to a fourth aspect, the invention provides a system for mitigating mechanical rattle in a host device arising due to a mechanical coupling of a speaker of the computing device to a part of the computing device, the system comprising: a rattle mitigation subsystem operative to apply an attenuation function to attenuate a component of an audio signal output to the speaker, wherein the rattle mitigation subsystem is configured to select one of a plurality of attenuation functions to apply based on an input to the rattle mitigation subsystem indicative of a type of audio content represented by the audio signal.

According to a fifth aspect, the invention provides a system for mitigating mechanical rattle in a computing device arising due to a mechanical coupling of a speaker of the computing device to a part of the computing device, wherein the computing device comprises a lid portion and a body portion the system comprising: a rattle mitigation subsystem operative to apply an attenuation function to attenuate a component of an audio signal output to the speaker, wherein the rattle mitigation subsystem is configured to adjust a tuning of the attenuation function based on an orientation of the lid portion and/or an orientation of the body portion.

According to a sixth aspect, the invention provides a system for mitigating mechanical rattle in a host device arising due to a mechanical coupling of a speaker of the computing device to a part of the computing device, the system comprising: a rattle mitigation subsystem operative to apply an attenuation function to attenuate a component of an audio signal output to the speaker, wherein the rattle mitigation subsystem is configured to adjust a parameter of the attenuation function based on an indication of ageing of the host device.

According to a seventh aspect, the invention provides a system for mitigating mechanical rattle in a host device arising due to a mechanical coupling of a speaker of the computing device to a part of the computing device, the system comprising: a rattle mitigation subsystem operative to apply an attenuation function to attenuate a component of an audio signal output to the speaker, wherein the rattle mitigation subsystem is configured to adjust a parameter of the attenuation function based on user-selected attenuation function configuration.

According to an eighth aspect second aspect, the invention provides an integrated circuit comprising a system according to any of the first to seventh aspects.

According to a ninth aspect, the invention provides a host device comprising a system according to any of the first to seventh aspects.

The host device may comprise, for example, a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device, or a vehicle.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1 is a schematic diagram illustrating the principle of mechanical resonance mitigation in an audio system of a host device;

FIG. 2 is a schematic diagram showing a host device having a system for mitigating mechanical rattle according to the present disclosure; and

FIG. 3 is a schematic diagram showing a user interface 300 of a rattle mitigation configuration application.

### DETAILED DESCRIPTION

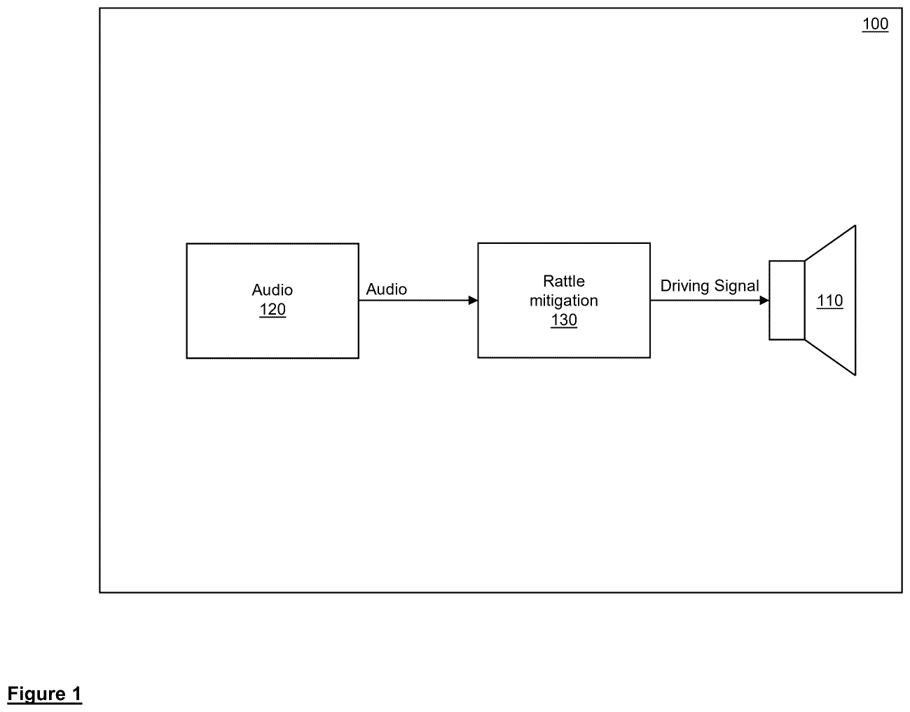

FIG. 1 is a schematic diagram illustrating the principle of mechanical resonance or rattle mitigation in an audio system of a host device.

As shown in FIG. 1, a host device 100, which may be a computing device such as a laptop, tablet, or all-in-one desktop computer, includes one or more audio output transducers 110 such as speakers, and an audio system 120 configured to generate an audio signal for driving the audio output transducer 110 to generate an audible output.

The audio output transducer 110 is mechanically coupled to (e.g. mounted on or attached to) a part of the host device 100, e.g. a frame, chassis, casing or housing of the host device 100.

The audio signal generated by the audio system 120 may represent, for example, speech from an audio or video telephony software application running on the host device 100, music from a music player application running on the host device 100, or sound effects and/or speech and/or music from a game or video player application running on the host device 100. The audio signal may be a digital audio signal or an analog signal. A digital audio signal may comprise a plurality of frames of audio data, each frame comprising one or more samples of an analog audio signal.

As noted above, the mounting arrangement of the audio output transducer 110 can give rise to mechanical rattle as a result of mechanical resonance of the host device 100 (or part of the host device 100) when an audio signal containing signal content at certain frequencies is supplied to the audio output transducer 110.

To reduce or mitigate the problem of mechanical rattle, the host device 100 includes a mechanical rattle mitigation subsystem 130. Although shown separately from the audio system 120 in FIG. 1, the mechanical rattle mitigation subsystem 130 may form part of the audio system 120 of the host device 100. Alternatively, the mechanical rattle mitigation subsystem 130 may be a standalone subsystem of the host device 100. The mechanical rattle mitigation subsystem 130 may be implemented in hardware (e.g. as one or more integrated circuits, or as discrete circuitry), or may be implemented in software running on appropriately configured hardware (e.g. firmware running on a digital signal processor, smart amplifier or the like to implement a suitable mechanical rattle mitigation algorithm).

The mechanical rattle mitigation subsystem 130 is configured to receive an audio signal output by the audio system 120 and to apply an attenuation function to this input audio signal to generate a driving signal to be output to the audio output transducer 110 to generate an audible output. The attenuation function applies frequency-specific attenuation to the received input audio signal to attenuate signal components of the input audio signal at one or more frequencies that cause mechanical rattle in the host device 100. The attenuation function may be implemented, for example, by one or more filters included in or implemented by the mechanical rattle mitigation subsystem 130.

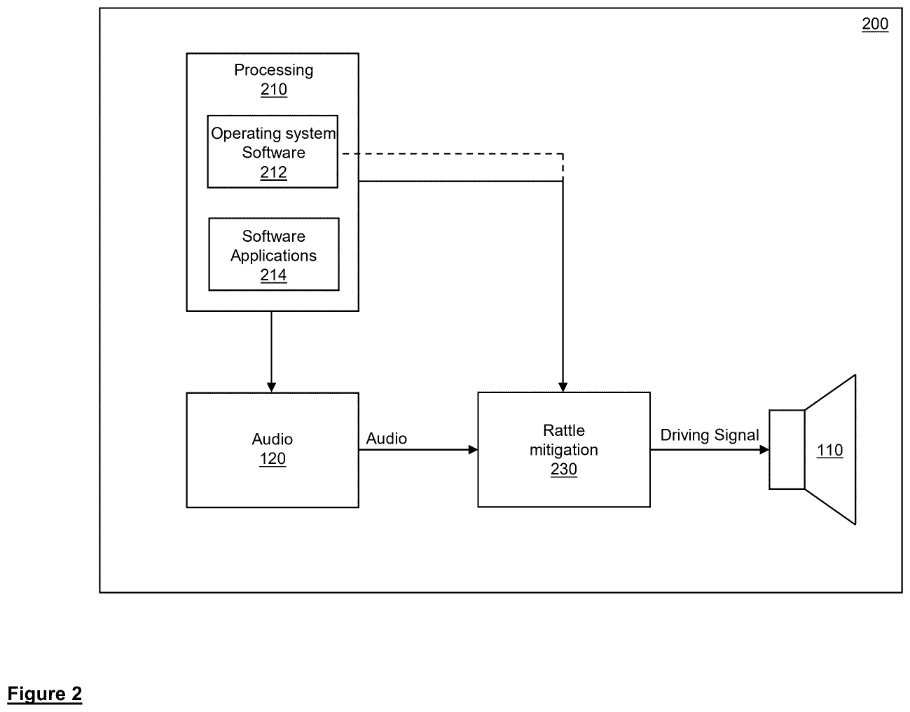

FIG. 2 is a schematic diagram showing a host device having a system for mitigating mechanical rattle according to the present disclosure. The host device 200 of FIG. 2 has a number of features in common with the host device 100 of FIG. 1, and so common reference numerals are used to denote common features of the host devices 100, 200 of FIGS. 1 and 2.

The host device 200 includes a processing subsystem 210 comprising one or more processors such as a central processing unit (CPU), graphics processing unit (GPU) or the like. In use of the host device 200, operating system software 212 is executed by the processing subsystem 210 to control operation of the host device 200. The operating system software 212 is typically installed on the host device 200 before it is supplied to a user, such that the host device 200 is pre-configured with the operating system software 212.

In use of the host device 200, one or more software applications 214 are also executed by the processing subsystem 210, to enable the host device 200 to perform specific tasks or functions. Examples of software applications include a media player application for playing media such as music and video, a video and/or audio telephony application, a voice-controlled assistant application, and games applications. Such software applications may be installed on the host device 200 before it is supplied to the user and/or may be obtained by the user (e.g. downloaded from an online application store) and installed on the host device 200.

The operating system software 212 is configured to receive, from the processing subsystem 210 and/or the software applications 214, information (e.g. signals, hardware interrupts, software interrupts, data or the like) relating to operational parameters of the host device 200. The operational parameters may include software parameters such as data identifying the software application(s) 214 currently being executed by the host device 200, audio parameters such as a type of audio content represented by an audio signal currently being output by the audio system 120, physical parameters such as a position or angle of orientation of a lid or screen portion of the host device 200 with respect to a body portion of the host device 200, and system parameters such as the age of the host device 200.

The host device 200 also includes a mechanical rattle mitigation subsystem 230. The mechanical rattle mitigation subsystem 230 is similar to the mechanical rattle mitigation subsystem 130 of the host device 100 of FIG. 1, in that it is configured to receive an audio signal output by the audio system 120 of the host device 200 and to apply an attenuation function to this input audio signal to generate a driving signal to be output to the audio output transducer 110 of the host device 200 to generate an audible output.

The mechanical rattle mitigation subsystem 230 differs from the mechanical rattle mitigation subsystem 130 of the host device 100 of FIG. 1 in that it is further configured to receive, from the host device 200 (e.g. from the processing subsystem 210 and/or the operating system software 212) an indication (e.g. a signal, interrupt, data structure or the like) of one or more operational parameters of the host device 200, and to adjust the attenuation function applied to the input audio signal based on the received indication.

For example, the mechanical rattle mitigation subsystem 230 may receive an audio content type indication, indicative of the type of audio content represented by the input audio signal, and may adjust the attenuation function applied to the input audio signal based on the received audio content type indication.

In one example, the audio content type indication may be generated by the operating system software 212 based on software application(s) 214 that are currently executing. In response to receiving the audio content type indication, the mechanical rattle mitigation subsystem 230 may adjust the attenuation function applied to the input audio signal accordingly, to provide a desired rattle mitigation effect for the indicated audio content type. For example, the mechanical rattle mitigation subsystem may adjust a tuning of the attenuation function, or may adjust a filter coefficient of one or more filters implemented by the mechanical rattle mitigation subsystem 230, or may select, from a set of predefined attenuation functions, a particular attenuation function that is configured to produce a desired rattle mitigation effect for the indicated audio content type.

For example, if a video or audio telephony application is currently executing, a first audio content type indication indicating that the audio content type is speech audio may be generated by the operating system software 212 and output (by the operating system software 212 or the processing subsystem 210) to the mechanical rattle mitigation subsystem 230. Responsive to receiving the first audio content type indication, the mechanical rattle mitigation subsystem 230 may adjust the attenuation function such that it applies a first predefined level of attenuation to a first subset of signal components (e.g. signal components having a frequency within a predefined frequency range) of the input audio signal that may otherwise give rise to mechanical rattle in the host device 200 to generate the driving signal for output to the audio output transducer 110.

In contrast, if a media player application is currently executing to play a movie file, a second audio content type indication indicating that the audio content type is movie audio may generated by the operating system software 212 and output (by the operating system software 212 or the processing subsystem 210) to the mechanical rattle mitigation subsystem 230. Movie audio may contain more high-frequency signal components than speech audio. Such high-frequency signal components may have the effect of masking, at least partially, the audible effects of mechanical rattle of the host device 200. Thus, when the audio content type is movie audio, a lower level of attenuation of the first subset of signal components may be required than when the audio content type is speech audio. Responsive to receiving the second audio content type indication, the mechanical rattle mitigation subsystem 230 may adjust the attenuation function such that it applies a second predefined level of attenuation (which is lower than the first predefined level of attenuation) to the first subset of signal components of the input audio signal. Additionally or alternatively, the mechanical rattle mitigation subsystem 230 may adjust the attenuation function to alter the signal components of the input signal to which attenuation is applied, such that no or little attenuation is applied to signal components of the input audio signal at frequencies that may mask the audible effects of mechanical rattle in the host device 200.

Similarly, if a game application is currently executing, a third audio content type indication indicating that the audio content type is game audio generated by the operating system software 212 and output (by the operating system software 212 or the processing subsystem 210) to the mechanical rattle mitigation subsystem 230. Responsive to receiving the third audio content type indication, the mechanical rattle mitigation subsystem 230 may adjust the attenuation function such that it applies a third predefined level of attenuation to the first subset of signal components (e.g. signal components having a frequency within a predefined frequency range) of the input audio signal that may otherwise give rise to mechanical rattle in the host device 200, and/or to adjust the attenuation function to alter the signal components of the input signal to which attenuation is applied, such that no or little attenuation is applied to signal components of the input audio signal at frequencies that may mask the audible effects of mechanical rattle in the host device 200.

In another example, the mechanical rattle mitigation subsystem 230 may receive a lid angle indication, indicative of an angle or orientation of a lid or screen portion of the host device 200 with respect to a body portion of the host device, and adjust the attenuation function applied to the input audio signal based on the received lid angle indication.

Some angles or orientations of the lid or screen portion of the host device 200 with respect to the body portion may give rise to, or exacerbate, mechanical rattle in the host device 200. By adjusting the attenuation function based on the angle or orientation of the lid or screen portion of the host device with respect to the body portion, the audible effects of mechanical rattle can be mitigated.

The lid angle indication may be generated by the processing subsystem 210 or the operating system software 212 based on a signal received from a lid angle sensor of the computing device 200, which may be, for example, coupled to the lid or screen portion of the host device 200. In some examples, the lid angle indication indicates whether or not the angle or orientation of the lid or screen portion of the host device with respect to the body portion exceeds a predefined lid angle threshold that represents an angle above (or below) which mechanical rattle is likely to occur in the host device 200. In other examples, the lid angle indication comprises a value indicative of the angle of the lid or screen portion of the host device 200 with respect to the body portion.

In response to receiving the lid angle indication, the mechanical rattle mitigation subsystem 230 may adjust the attenuation function applied to the input audio signal accordingly, to provide a desired rattle mitigation effect for the indicated lid angle. For example, the mechanical rattle mitigation subsystem 230 may adjust a tuning of the attenuation function, or may adjust a filter coefficient of one or more filters implemented by the mechanical rattle mitigation subsystem 230, or may select, from a set of predefined attenuation functions, a particular attenuation function that is configured to produce a desired rattle mitigation effect for the indicated lid angle.

Where the lid angle indication comprises a value of the angle of the lid or screen portion of the host device 200 with respect to the body portion, the mechanical rattle mitigation subsystem 230 may adjust the attenuation function applied to the input audio signal based on the value, such that a first adjustment of the attenuation function is made by the mechanical rattle mitigation subsystem 230 for a first value of the lid angle indication, a second adjustment of the attenuation function is made by the mechanical rattle mitigation subsystem 230 for a second value of the lid angle indication, and a third adjustment of the attenuation function is made by the mechanical rattle mitigation subsystem 230 for a third value of the lid angle indication, etc.

Where the lid angle indication comprises an indication of whether or not the angle or orientation of the lid or screen portion of the host device 200 with respect to the body portion exceeds a predefined lid angle threshold, the mechanical rattle mitigation subsystem 230 may adjust the attenuation function only if the lid angle indication indicates that the angle or orientation of the lid or screen portion of the host device 200 with respect to the body portion exceeds the predefined lid angle threshold.

In another example, the mechanical rattle mitigation subsystem 230 may receive a body angle indication, indicative of an angle or orientation of the body portion of the host device 200 with respect to a reference orientation, and adjust the attenuation function applied to the input audio signal based on the received lid angle indication.

Some angles or orientations of the body portion of the host device 200 with respect to a reference orientation such as a generally horizontal orientation may give rise to, or exacerbate, mechanical rattle in the host device 200. For example, if the host device 200 is placed on an angled stand or the like, this may give rise to or exacerbate mechanical rattle in the host device 200.

By adjusting the attenuation function based on the angle or orientation of the body portion with respect to the reference orientation, the audible effects of mechanical rattle can be mitigated.

Thus, in response to receiving the body angle indication, the mechanical rattle mitigation subsystem 230 may adjust the attenuation function applied to the input audio signal accordingly, to provide a desired rattle mitigation effect for the indicated body angle. For example, the mechanical rattle mitigation subsystem 230 may adjust a tuning of the attenuation function, or may adjust a filter coefficient of one or more filters implemented by the mechanical rattle mitigation subsystem 230, or may select, from a set of predefined attenuation functions, a particular attenuation function that is configured to produce a desired rattle mitigation effect for the indicated body angle.

The body angle indication may be generated by the processing subsystem 210 or the operating system software 212 based on a signal received from a sensor such as an accelerometer provided in or coupled to the body portion of the host device 200. In some examples, the body angle indication indicates whether or not the angle or orientation of the body portion of the host device 200 with respect to the reference orientation exceeds a predefined body angle threshold that represents an angle above (or below) which mechanical rattle is likely to occur in the host device 200. In other examples, the body angle indication comprises a value indicative of the angle of the body portion of the host device 200 with respect to the reference orientation.

Where the body angle indication comprises a value of the body portion of the host device 200 with respect to the reference orientation, the mechanical rattle mitigation subsystem 230 may adjust the attenuation function applied to the input audio signal based on the value, such that a first adjustment of the attenuation function is made by the mechanical rattle mitigation subsystem 230 for a first value of the body angle indication, a second adjustment of the attenuation function is made by the mechanical rattle mitigation subsystem 230 for a second value of the body angle indication, and a third adjustment of the attenuation function is made by the mechanical rattle mitigation subsystem 230 for a third value of the body angle indication, etc.

Where the body angle indication comprises an indication of whether or not the angle or orientation of the body portion of the host device 200 with respect to the reference orientation exceeds a predefined body angle threshold, the mechanical rattle mitigation subsystem 230 may adjust the attenuation function only if the body angle indication indicates that the angle or orientation of the body portion of the host device 200 with respect to the reference orientation exceeds the predefined body angle threshold.

As the host device 200 ages, internal components may begin to loosen, which may affect the characteristic acoustic behaviour of the host device 200, e.g. by changing the frequencies or frequency ranges of signal components of the audio output of the audio output transducer 110 that will give rise to mechanical rattle in the host device 200, and/or by changing the magnitude of signal components of the audio output of the audio output transducer 110 that will give rise to mechanical rattle in the host device 200, and/or by changing a level (e.g. magnitude) of the mechanical rattle that arises in the host device 200.

Thus, it may be beneficial to adjust the attenuation function applied by the mechanical rattle mitigation subsystem 230 based on the age of the host device 200.

Accordingly, in some examples, the mechanical rattle mitigation subsystem 230 may receive a host device age indication, indicative of an age of the host device 200, and adjust the attenuation function applied to the input audio signal based on the received host device age indication.

In response to receiving the host device age indication, the mechanical rattle mitigation subsystem 230 may adjust the attenuation function applied to the input audio signal accordingly, to provide a desired rattle mitigation effect for the indicated host device age. For example, the mechanical rattle mitigation subsystem 230 may adjust a tuning of the attenuation function, or may adjust a filter coefficient of one or more filters implemented by the mechanical rattle mitigation subsystem 230, or may select, from a set of predefined attenuation functions, a particular attenuation function that is configured to produce a desired rattle mitigation effect for the indicated host device age.

The host device age indication may be generated by the processing subsystem 210 or the operating system software 212, e.g. based on a BIOS date, serial number or other information of the host device 200 that may be read from a memory of the host device 200 by the processing subsystem 210 or the operating system software 212. The host device age indication may comprise, a value indicating the age of the host device 200, or a value indicative of an age range of the host device, e.g. 0-1 years, 1-2 years, 2-3 years, etc.

Responsive to receiving the host device age indication, the mechanical rattle mitigation subsystem 230 may adjust the attenuation function applied to the input audio signal based on the age indication, such that, for example, a first adjustment of the attenuation function is made by the mechanical rattle mitigation subsystem 230 if the host device age indication indicates that the age of the device is below a first threshold, a second adjustment of the attenuation function is made by the mechanical rattle mitigation subsystem 230 if the host device age indication indicates that the age of the device is between the first threshold and a second threshold, and a third adjustment of the attenuation function is made by the mechanical rattle mitigation subsystem 230 if the host device age indication indicates that the age of the device is equal to or greater than the second threshold.

In some examples, one or more parameters of the mechanical rattle mitigation subsystem 230 are configurable by a user of the host device 200 using a rattle mitigation configuration application. Such a rattle mitigation configuration application may allow the user to configure or adjust one or more of the following parameters of the mechanical rattle mitigation subsystem 230: a level of attenuation applied by the attenuation function implemented by the mechanical rattle mitigation subsystem 230; a frequency profile of the attenuation function, e.g. frequencies of components of the input audio signal to be attenuated by the attenuation function; an input audio signal level threshold at which the attenuation function is to be applied; and an attack rate or speed at which the attenuation function is to be applied by the mechanical rattle mitigation subsystem 230. A user rattle mitigation configuration indication, indicative of a user's configuration of the one or more parameters of the mechanical rattle mitigation subsystem 230, may be generated by the processing subsystem 210 or the operating system software 212, e.g. based on one or more user inputs to a user interface of the host device 200.

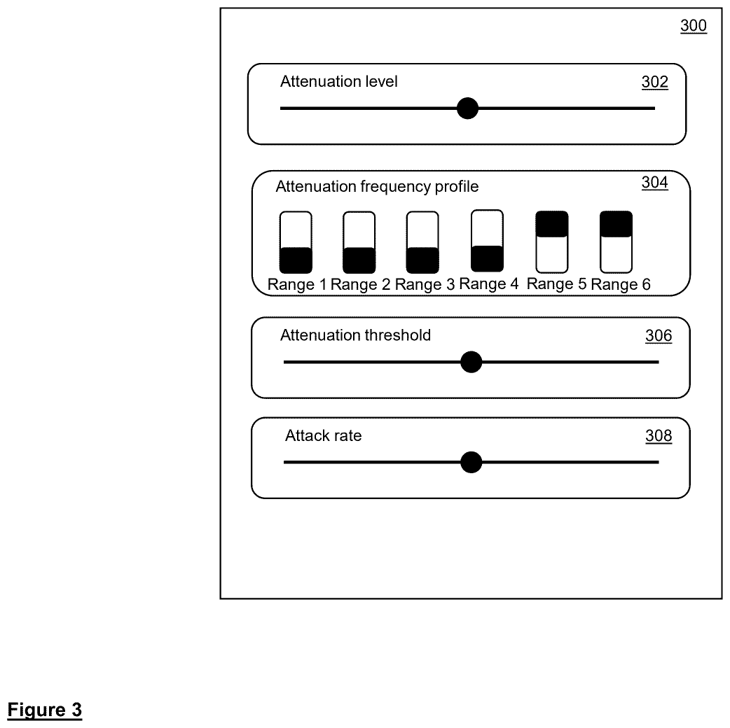

FIG. 3 is a schematic diagram showing a user interface 300 of a rattle mitigation configuration application that may be provided as part of the operating system software 212. The user interface 300 includes a first control 302 (which in this example is a slider control) for allowing the user to configure or adjust the level of attenuation applied by the attenuation function. The user interface 300 further includes a second control 304 (which in this example is a set of toggle switch controls) for allowing the user to configure or adjust a frequency profile of the attenuation function, e.g. the frequencies or frequency ranges of the input audio signal to be attenuated by the attenuation function. The user interface 300 further includes a third control 306 (which in this example is a slider control) for allowing the user to configure or adjust an attenuation threshold that determines the level of the input audio signal at which the attenuation function is applied by the mechanical rattle mitigation subsystem 230. The user interface 300 further includes a fourth control 308 (which in this example is a slider control) for allowing the user to configure or adjust the attack rate or speed at which the attenuation function is to be applied by the mechanical rattle mitigation subsystem 230.

Responsive to receiving a user input on one or more of the controls 302-308, the mechanical rattle mitigation subsystem 230 adjusts the associated parameter(s) of the attenuation function according to the user input. For example, the mechanical rattle mitigation subsystem 320 may increase or decrease the level of attenuation applied by the attenuation function according to an attenuation level selected by the user using the first control 302, and/or may adjust the frequencies or frequency ranges of the input audio signal that will be attenuated by the attenuation function according to the frequencies or frequency ranges selected by the user using the second control 304 (e.g. by adjusting a tuning of the attenuation function, adjusting a filter coefficient of one or more filters implemented by the mechanical rattle mitigation subsystem 230, or by selecting, from a set of predefined attenuation functions, a particular attenuation function that implements attenuation of the user-selected frequencies or frequency ranges), and/or may adjust the level of the input audio signal at which the attenuation function is applied according to the attenuation threshold selected by the user using the third control, and/or may adjust the attack rate or speed at which the attenuation function is applied based on an attack rate selected by the user using the fourth control 308.

In some examples, instead of (or in addition to) the first to fourth controls 302-308, the user interface 300 may include a single rattle mitigation control, e.g. a slider, dial or the like, for allowing the user to configure or adjust a parameter, or a combination of two or more parameters, of the attenuation function e.g. the level of attenuation applied by the attenuation function, the frequencies or frequency ranges of the input audio signal that will be attenuated by the attenuation function, a filter coefficient of one or more filters implemented by the mechanical rattle mitigation subsystem 230, the level of the input audio signal at which the attenuation function is applied, and/or may adjust the attack rate or speed at which the attenuation function is applied.

Thus, responsive to receiving a user input on the rattle mitigation control of the user interface 300, the mechanical rattle mitigation subsystem 230 adjusts a single parameter or a combination of two or more parameters to reduce or mitigate the effects of mechanical rattle of the host device 200. Whether a single parameter or a combination of two or more parameters is adjusted in response to receiving a user input on the rattle mitigation control may be dependent upon an indication (e.g. a signal, interrupt, data structure or the like) of one or more operational parameters of the host device 200 of the kind described above, such as an audio content type indication, a lid angle indication, a body angle indication or a device age indication.

The audible effects of mechanical rattle may only be manifested, or may only be noticeable, if a level (e.g. amplitude) of the audio input signal is equal to or greater than a threshold audio input signal level. Thus, at audio input signal levels below this threshold level, the mechanical rattle mitigation subsystem 230 may be redundant, in the sense that there is no need to apply the attenuation function to the audio input signal to generate the driving signal for the audio output transducer 110, since mechanical rattle will not be manifested or noticeable.

Thus, in some examples, the host device 200 may be configured to switch the mechanical rattle mitigation subsystem 230 into a low-power state (e.g. a sleep mode or a deactivated or disabled state) to reduce a power consumption of the host device 200 if a volume setting for the host device 200 falls below a predefined volume threshold.

As will be appreciated by those of ordinary skill in the art, the volume setting of the host device 200 controls (at least partially) the level of the audio input signal. Thus, if the volume setting falls below the predefined volume threshold, the level of the audio input signal will fall below the threshold audio input signal level, rendering the mechanical rattle mitigation subsystem 230 redundant. By switching the mechanical rattle mitigation subsystem 230 into the low-power state if the volume setting falls below the predefined volume threshold, the power consumption of the host device 200 may be reduced.

The user may control the volume setting of the host device 200 using one or more physical volume controls (e.g. one or more buttons, keys, dials or sliders) of the host device and/or using one or more software controls that may be accessible, for example, in a settings application of the operating system software 212.

The processing subsystem 210 may be configured to, responsive to a trigger condition such as start-up of the host device 200, start-up of a software application 214 or a change made by the user to the volume setting, compare (in hardware or software) a current volume setting to the predefined volume threshold, and to output a control signal (e.g. a hardware or software interrupt) to the mechanical rattle mitigation subsystem 230 to cause the mechanical rattle mitigation subsystem 230 to switch into the low-power mode if the current volume setting is below the predefined volume threshold.

Alternatively, the mechanical rattle mitigation subsystem 230 may be configured to receive, from the processing subsystem 210, a signal indicative of the current volume setting, and to compare the received signal indicative of the current volume setting to a signal indicative of the predefined volume threshold. If the current volume setting is lower than the predefined volume threshold, the mechanical rattle mitigation subsystem 230 may be configured to switch itself into the low-power mode.

The processing subsystem 210 may, periodically and/or in response to a trigger condition such as a start-up of a software application 214 or a change made by the user to the volume setting, compare (in hardware or software) the current volume setting to the predefined volume threshold, and to output a control signal (e.g. a hardware or software interrupt) to the mechanical rattle mitigation subsystem 230 to cause the mechanical rattle mitigation subsystem 230 to exit the low-power mode if the current volume setting is equal to or greater than the predetermined volume threshold.

In some examples, the host device 200 may be configured to switch the mechanical rattle mitigation subsystem 230 into the low-power state (e.g. a sleep mode or a deactivated or disabled state) to reduce a power consumption of the host device 200 if an external accessory device that includes an audio output transducer (e.g. a wired or wireless speaker, wired or wireless earphones, headphones or the like) is coupled to the host device 200. When such an external accessory device is coupled to the host device 200, the problem of mechanical rattle does not arise in the host device 200 itself, and thus the mechanical rattle mitigation subsystem 230 is redundant in such situations.

Accordingly, the processing subsystem 210 may be configured to, responsive to detection of an external accessory device that includes an audio output transducer being coupled to the host device 200, output a control signal (e.g. a hardware or software interrupt) to the mechanical rattle mitigation subsystem 230 to cause the mechanical rattle mitigation subsystem 230 to switch into the low-power mode. Responsive to detection that the external accessory device has been decoupled from the host device 200, the processing subsystem 210 may output a control signal (e.g. a hardware or software interrupt) to the mechanical rattle mitigation subsystem 230 to cause the rattle mitigation subsystem 230 to exit the low-power mode.

Some software applications 214 may include its own audio processing functionality. For example, a voice-controlled assistant application may include audio processing functionality for improving intelligibility of audible outputs “spoken” by the application, whereas a media player application may audio processing functionality for improving the fidelity of output audio.

In some circumstances it may be beneficial for the audio processing functionality of the software application 214 to be used in preference to the attenuation function implemented by the mechanical rattle mitigation subsystem 230. Thus, in some examples, the processing subsystem 210 may be configured to, responsive to start-up of a software application 214 that includes its own audio processing functionality, output a control signal (e.g. a hardware or software interrupt) to the mechanical rattle mitigation subsystem 230 to cause the mechanical rattle mitigation subsystem 230 to switch into the low-power mode. Responsive to detection that the software application 214 has been shut down, the processing subsystem 210 may output a control signal (e.g. a hardware or software interrupt) to the mechanical rattle mitigation subsystem 230 to cause the rattle mitigation subsystem 230 to exit the low-power mode.

In other circumstances it may be beneficial for the attenuation function implemented by the mechanical rattle mitigation subsystem 230 to be used in preference to the audio processing functionality of the software application 214. Thus, in some examples, the processing subsystem 210 may be configured to, responsive to start-up of a software application 214 that includes its own audio processing functionality, output a control signal to the software application 214 disable the audio processing of the software application as described above.

In some examples, the processing subsystem 210 may be operative to prompt a user of the host device 200, e.g. using a user interface element of the operating system software 212, to select between the audio processing functionality of the software application and the attenuation function implemented by the mechanical rattle mitigation subsystem 230. In response to the user's selection of the audio processing functionality of the software application, the processing subsystem 210 may output a control signal (e.g. a hardware or software interrupt) to the mechanical rattle mitigation subsystem 230 to cause the mechanical rattle mitigation subsystem 230 to switch into the low-power mode as described above. In response to the user's selection of the attenuation function, the processing subsystem 210 may output a control signal to the software application 214 disable the audio processing of the software application 214 as described above.

The mechanical rattle mitigation subsystem 230 may be implemented in hardware, e.g. as part of an audio amplifier or codec integrated circuit (IC) or in discrete circuitry within the host device 200. Alternatively, the mechanical rattle mitigation subsystem 230 may be implemented in software executing on suitable processing hardware, e.g. a digital signal processor (DSP), amplifier or codec IC or a general-purpose processor of the processing subsystem 210.

As will be appreciated by those of ordinary skill in the art, the problem of mechanical rattle or resonance is not unique or specific to computing devices. Mechanical rattle or other undesirable effects arising from mechanical resonance at audio frequencies may also occur in other applications in which an audio output transducer is mechanically coupled to a part of a host device, e.g. in automotive audio systems in which speakers are mechanically mounted on or otherwise coupled to panels of the interior of the vehicle. The systems and methods described herein are applicable to such other applications. Accordingly, the present disclosure extends to a system for mitigating mechanical rattle more generally, and to a system for mitigating resonance at audio frequencies.

The circuitry described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A system for mitigating mechanical rattle in a computing device arising due to a mechanical coupling of a speaker of the computing device to a part of the computing device, wherein the computing device comprises a processing subsystem comprising one or more processors configured to execute operating system software and a software application, the system comprising:
a rattle mitigation subsystem operative to apply an attenuation function to attenuate a component of an audio signal output to the speaker,
wherein the rattle mitigation subsystem is configured to receive, from the computing device, an indication of an operational parameter of the computing device, and to adjust the attenuation function based on the received indication.

2. The system of claim 1, wherein the rattle mitigation subsystem is configured to adjust the attenuation function based on the received indication by:
adjusting a tuning of the attenuation function; and/or
adjusting a filter coefficient of one or more filters implemented by the rattle mitigation subsystem; and/or
selecting, from a set of predefined attenuation functions, a particular attenuation function; and/or
adjusting a level of attenuation applied by the attenuation function; and/or
adjusting a frequency profile of the attenuation function; and/or
adjusting an input signal level threshold at which the attenuation function is to be applied; and/or
adjusting an attack rate of the attenuation function.

3. The system of claim 1, wherein the indication comprises one or more of:
an audio content type indication indicative of the type of audio content represented by the audio signal;
a lid angle indication indicative of an angle or orientation of a lid or screen portion of the computing device with respect to a body portion of the computing device;
a body angle indication indicative of an angle or orientation of the body portion of the computing device with respect to a reference orientation;
a device age indication indicative of an age of the computing device; and
a user rattle mitigation configuration indication indicative of a user configuration of one or more parameters of the rattle mitigation subsystem.

4. The system of claim 1, wherein the operating system software is configured to generate the audio content type indication based on a software application that is being executing by the processing subsystem.

5. The system of claim 3, wherein the rattle mitigation subsystem is configured to:
responsive to receiving a first audio content type indication:
adjust the attenuation function such that it applies a first predefined level of attenuation to a first subset of signal components of the audio signal;
responsive to receiving a second content type indication:
adjust the attenuation function such that it applies a second predefined level of attenuation, lower than the first predefined level of attenuation, to the first subset of signal components of the audio signal; and
responsive to receiving a third content type indication:
adjust the attenuation function such that it applies a third predefined level of attenuation to the first subset of signal components of the audio signal.

6. The system of claim 3, wherein the processing subsystem or the operating system software is configured to generate the lid angle indication based on a signal received from a lid angle sensor of the computing device.

7. The system of claim 3, wherein the processing subsystem or the operating system software is configured to generate the body angle indication based on a signal received from a body angle sensor of the computing device.

8. The system of claim 3, wherein the processing subsystem or the operating system software is configured to generate the device age indication based on one or more of a BIOS date or serial number of the computing device.

9. The system of claim 3, wherein the processing subsystem or the operating system software is configured to generate the user rattle mitigation configuration indication based on a user input to a user interface of the computing device.

10. The system of claim 9, wherein the user interface of the computing device comprises a rattle mitigation control for user configuration of a parameter or a combination of two or more of the following parameters of the attenuation function:
a level of attenuation applied by the attenuation function; and/or
a frequency profile of the attenuation function; and/or
an input signal level threshold at which the attenuation function is to be applied; and/or
an attack rate of the attenuation function.

11. The system of claim 9, wherein the user interface of the computing device comprises controls for user configuration of:
a level of attenuation applied by the attenuation function; and/or
a frequency profile of the attenuation function; and/or
an input signal level threshold at which the attenuation function is to be applied; and/or
an attack rate of the attenuation function.

12. The system of claim 1, wherein the rattle mitigation subsystem is operative to apply the attenuation function only if a level of the audio signal is equal to or greater than a threshold audio signal level.

13. The system of claim 1, wherein the system is configured to control an operating mode of the rattle mitigation subsystem based on a comparison of a volume setting of the computing device to a predefined volume threshold.

14. The system of claim 13, wherein the processing subsystem is configured to:
cause the rattle mitigation subsystem to enter a low-power mode of operation if the volume setting is below the predefined volume threshold; and
cause the rattle mitigation subsystem to exit the low-power mode if the volume setting is equal to or greater than the predetermined volume threshold.

15. The system of claim 13, wherein the processing subsystem is configured to perform the comparison periodically and/or in response to a trigger condition.

16. The system of claim 1, wherein the system is configured to cause the rattle mitigation subsystem to enter a low-power mode of operation responsive to detection of an external accessory device that includes an audio output transducer being coupled to the computing device.

17. The system of claim 1, wherein the system is configured to cause the rattle mitigation subsystem to enter a low-power mode of operation responsive to start-up of a software application that includes audio processing functionality.

18. The system of claim 1, wherein the system is configured to disable audio processing functionality of a software application responsive to start-up of the software application.

19. A system for mitigating mechanical rattle in a host device arising due to a mechanical coupling of a speaker of the host device to a part of the host device, the system comprising:
a rattle mitigation subsystem operative to apply an attenuation function to attenuate a component of an audio signal output to the speaker,
wherein the rattle mitigation subsystem is configured to adjust a tuning of the attenuation function based on an input to the rattle mitigation subsystem indicative of a type of audio content represented by the audio signal.

20. A system for mitigating mechanical rattle in a host device arising due to a mechanical coupling of a speaker of the host device to a part of the host device, the system comprising:
a rattle mitigation subsystem operative to apply an attenuation function to attenuate a component of an audio signal output to the speaker,
wherein the rattle mitigation subsystem is configured to adjust a parameter of the attenuation function based on a type of audio content represented by the audio signal.

21. A system for mitigating mechanical rattle in a host device arising due to a mechanical coupling of a speaker of the computing device to a part of the computing device, the system comprising:
a rattle mitigation subsystem operative to apply an attenuation function to attenuate a component of an audio signal output to the speaker,
wherein the rattle mitigation subsystem is configured to select one of a plurality of attenuation functions to apply based on an input to the rattle mitigation subsystem indicative of a type of audio content represented by the audio signal.

22. A system for mitigating mechanical rattle in a computing device arising due to a mechanical coupling of a speaker of the computing device to a part of the computing device, wherein the computing device comprises a lid portion and a body portion the system comprising:
a rattle mitigation subsystem operative to apply an attenuation function to attenuate a component of an audio signal output to the speaker,
wherein the rattle mitigation subsystem is configured to adjust a tuning of the attenuation function based on an orientation of the lid portion and/or an orientation of the body portion.

23. A system for mitigating mechanical rattle in a host device arising due to a mechanical coupling of a speaker of the computing device to a part of the computing device, the system comprising:
a rattle mitigation subsystem operative to apply an attenuation function to attenuate a component of an audio signal output to the speaker,
wherein the rattle mitigation subsystem is configured to adjust a parameter of the attenuation function based on an indication of ageing of the host device.

24. A system for mitigating mechanical rattle in a host device arising due to a mechanical coupling of a speaker of the computing device to a part of the computing device, the system comprising:
a rattle mitigation subsystem operative to apply an attenuation function to attenuate a component of an audio signal output to the speaker,
wherein the rattle mitigation subsystem is configured to adjust a parameter of the attenuation function based on user-selected attenuation function configuration.

25. An integrated circuit comprising a system according to claim 1.

26. A host device comprising a system according to claim 1.

27. A host device according to claim 26, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device, or a vehicle.
